(19) United States
(12) Patent Application Publication
(10) Pub. No.: US 2016/0127070 A1
(43) Pub. Date: May 5, 2016

(54) INTEGRATED TWO-CHANNEL SPECTRAL COMBINER AND WAVELENGTH LOCKER IN SILICON PHOTONICS

(71) Applicant: INPHI CORPORATION, Santa Clara, CA (US)

(72) Inventors: Radhakrishnan L. NAGARAJAN, Santa Clara, CA (US); Masaki KATO, Palo Alto, CA (US)

(21) Appl. No.: 14/530,146

(22) Filed: Oct. 31, 2014

(51) Int. Cl. H04J 14/02

(52) U.S. Cl. CPC H04J 14/0227

(57) ABSTRACT

A two-channel DWDM spectral combiner integrated with a wavelength locker is provided. Two optical signals at ITU grid channels are separately modulated by MZM modulators and combined into a silicon waveguide-based delayed-line interferometer built on silicon-on-insulator substrate to produce a combined signal having a free spectral range equal to twice of the spacing of the two ITU grid channels. Two dither signals can be added respectively to the two optical signals for identifying corresponding two channel wavelengths and locking each wavelength while outputting the combined signal.

### BACKGROUND OF THE INVENTION

The present invention relates to optical telecommunication techniques. More particularly, the present invention provides an integrated two-channel spectral combiner and waveguide-based wavelength locker in silicon photonics.

Over the last few decades, the use of communication networks exploded. In the early days Internet, popular applications were limited to emails, bulletin board, and mostly informational and text-based web page surfing, and the amount of data transferred was usually relatively small. Today, Internet and mobile applications demand a huge amount of bandwidth for transferring photo, video, music, and other multimedia files. For example, a social network like Facebook processes more than 500 TB of data daily. With such high demands on data and data transfer, existing data communication systems need to be improved to address these needs.

40-Gbit/s and then 100-Gbit/s data rates DWDM optical transmission over existing single-mode fiber is a target for the next generation of fiber-optic communication networks. The big hangup so far has been the fiber impairments like chromatic dispersion that are slowing the communication signal down. Everything is okay up to 10 Gbits/s plus a little for distance less than 100 km and at 1300 nm transmission wavelength, but beyond that, distortion and attenuation take their toll. Many approaches are proposed on modulation methods for transmitting two or more bits per symbol so that higher communication rates can be achieved. Mach-Zehnder modulators (MZM) can handle the higher data rates but require a driver that is differential with a wide output voltage swing.

Conventional wavelength locker is a typically Etalon-based stand-alone device. An obvious drawback is its large size. Although it can be integrated directly with a laser module, it only makes the laser module bigger. Therefore, improved techniques and methods are desired.

### BRIEF SUMMARY OF THE INVENTION

The present invention relates to optical telecommunication techniques. More particularly, the present invention provides an integrated two-channel spectral combiner and waveguide-based wavelength locker in silicon photonics. Merely by example, the present invention discloses a silicon photonics device integrated a pair of amplitude modulators with a two-channel wavelength combiner/locker in a single chip for combining a pair of laser signals into one fiber and a method for locking both wavelengths for high data rate DWDM optical communications, though other applications are possible.

In modern electrical interconnect systems, high-speed serial links have replaced parallel data buses, and serial link speed is rapidly increasing due to the evolution of CMOS technology. Internet bandwidth doubles almost every two years following Moore's Law. But Moore's Law is coming to an end in the next decade. Standard CMOS silicon transistors will stop scaling around 5 nm. And the internet bandwidth increasing due to process scaling will plateau. But Internet and mobile applications continuously demand a huge amount of bandwidth for transferring photo, video, music, and other multimedia files. This disclosure describes techniques and methods to improve the communication bandwidth beyond Moore's law.

In an embodiment, the present invention provides a silicon photonics device for combining two optical signals while locking corresponding wavelengths. The silicon photonics device includes a first waveguide having a first path length from a first end to a second end laid in a first region of the substrate and a second waveguide having a second path length from a third end to a fourth end. The second path length is longer than the first path length by a delayed-line length laid in a second region of the substrate. The silicon photonics device further includes a heater component overlying substantially entire second region of the substrate. Additionally, the silicon photonics device includes an input coupler configured to connect a first signal with a first wavelength and a second signal with a second wavelength to both the first end of the first waveguide and the third end of the second waveguide. Furthermore, the silicon photonics device includes an output coupler configured to connect the second end of the first waveguide and the fourth end of the second waveguide to an output port with an combined signal comprising a first interference spectrum of the first signal with a first free spectral range associated with the first wavelength interleaved with a second interference spectrum of the second signal with a second free spectral range associated with the second wavelength. The delayed-line length and the heater component are configured to determine the first free spectral range being equal to the second free spectral range and equal to twice of difference between the first wavelength and the second wavelength as the first wavelength and the second wavelength are respectively locked to corresponding channels of ITU grid.

In an alternative embodiment, the present invention provides a method of using a silicon photonics device for combining two optical signals while locking corresponding wavelengths. The method includes coupling a first optical signal characterized by a first wavelength to split into a first waveguide path having a first length and a second waveguide path having a second length. The second length is longer than the first length by a specific delayed-line length to provide a first interference spectrum having a first free-spectral range between two successive passband peaks associated with the first wavelength. The method further includes coupling a second optical signal characterized by a second wavelength to split into the first waveguide path and the second waveguide path to provide a second interference spectrum having a second free spectral range between two successive passband peaks associated with the second wavelength. The second free spectral range is equal to the first free-spectral range and is configured to be equal to twice of difference between the first wavelength and the second wavelength. Additionally, the method includes incorporating a first dither signal into the first optical signal and incorporating a second dither signal into the second optical signal. The method further includes forming a combined signal in one output port of both the first waveguide path and the second waveguide path. The combined signal includes the first interference spectrum and the second interference spectrum. Furthermore, the method includes extracting the first dither signal and the second dither signal from the combined signal. The method further includes measuring a power strength of a tapped fraction of the combined signal and calculating first derivatives of the power strength respectively at the first dither signal and the second dither signal. Moreover, the method includes identifying and locking the first wavelength and the second wavelength by maximizing the power strength and nulling the first derivatives respectively at the first dither signal and the second dither signal.

In principle any number of wavelengths can be locked in a similar way described above. The two-channel spectral combiner and wavelength locker based on delay-line-interferometer is in effect an interleaver. Any stream of wavelengths, e.g., 100 GHz apart, in any one arm of the interferometer, can be combined using the delay-line phase change mechanism. Since the delay-line-interferometer spectral response is periodic, all of wavelengths can be locked to their respective ITU grids. Each wavelength signal can be tagged individually with a dither frequency, or using a TDM approach, and cycling through a single dither frequency over multiple-wavelength signals and lock the wavelengths individually.

The present invention achieves these benefits and others in the context of known waveguide laser modulation technology. However, a further understanding of the nature and advantages of the present invention may be realized by reference to the latter portions of the specification and attached drawings.

### BRIEF DESCRIPTION OF THE DRAWINGS

The following diagrams are merely examples, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

FIG. 1 is a simplified diagram of a MZM with decoupled bias/current modulation according to an embodiment of the present invention.

FIG. 2 is a simplified diagram of a MZM with taped signals from both output and its complementary output as merit for control according to an embodiment of the present invention.

FIG. 3 is a simplified diagram of two MZMs connected to an integrated two-channel spectral combiner and wavelength locker implemented in silicon photonics according to an embodiment of the present invention.

FIG. 4 is a simplified diagram showing a waveguide configuration of the integrated two-channel spectral combiner and wavelength locker according to an embodiment of the present invention.

FIG. 5 is a simplified flowchart of a method for wavelength locking control using the integrated two-channel spectral combiner and wavelength locker according to an embodiment of the present invention.

### DETAILED DESCRIPTION OF THE INVENTION

The present invention relates to optical telecommunication techniques. More particularly, the present invention provides an integrated two-channel spectral combiner and waveguide-based wavelength locker in silicon photonics. Merely by example, the present invention discloses a silicon photonics device integrated a pair of MZMs (Mach Zehnder Modulator) with a two-channel wavelength combiner and non-Etalon-based locker in a single chip for combining a pair of laser signals into one fiber and a method for locking both wavelengths for high data rate WDM optical communications, though other applications are possible.

In the last decades, with advent of cloud computing and data center, the needs for network servers have evolved. For example, the three-level configuration that have been used for a long time is no longer adequate or suitable, as distributed applications require flatter network architectures, where server virtualization that allows servers to operate in parallel. For example, multiple servers can be used together to perform a requested task. For multiple servers to work in parallel, it is often imperative for them to be share large amount of information among themselves quickly, as opposed to having data going back forth through multiple layers of network architecture (e.g., network switches, etc.).

Leaf-spine type of network architecture is provided to better allow servers to work in parallel and move data quickly among servers, offering high bandwidth and low latencies. Typically, a leaf-spine network architecture uses a top-of-rack switch that can directly access into server nodes and links back to a set of non-blocking spine switches that have enough bandwidth to allow for clusters of servers to be linked to one another and share large amount of data.

In a typical leaf-spine network today, gigabits of data are shared among servers. In certain network architectures, network servers on the same level have certain peer links for data sharing. Unfortunately, the bandwidth for this type of set up is often inadequate. It is to be appreciated that embodiments of the present invention utilizes PAM (e.g., PAM4, PAM8, PAM12, PAM16, etc.) in leaf-spine architecture that allows large amount (up terabytes of data at the spine level) of data to be transferred via optical network.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

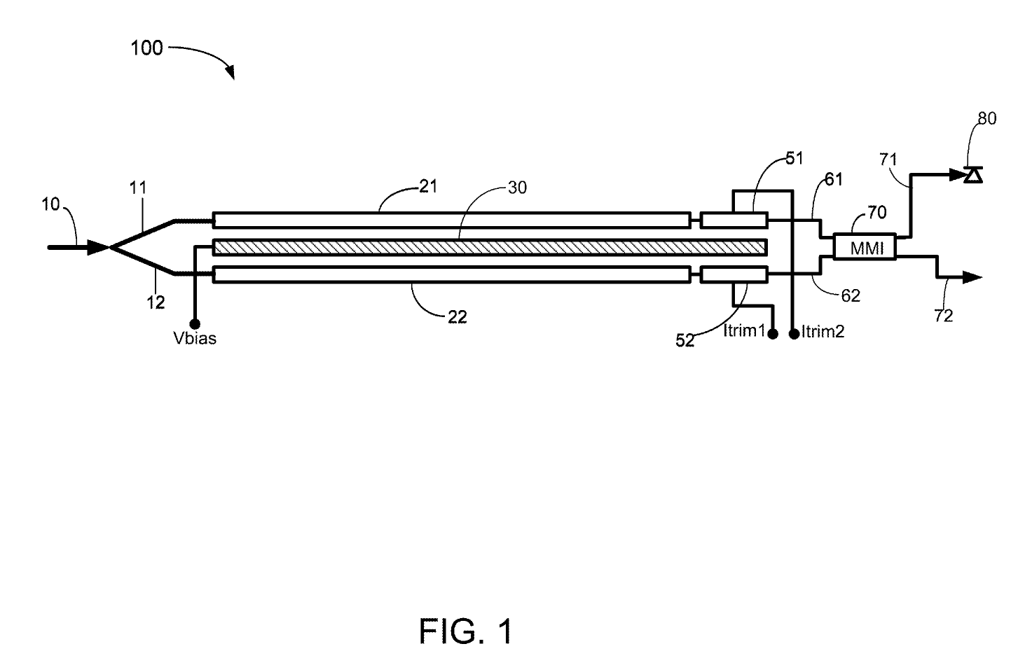

FIG. 1 is a simplified diagram of a MZM with decoupled bias/current modulation according to an embodiment of the present invention. This diagram is merely an example, which should not unduly limit the scope of the claims. One of ordinary skill in the art would recognize many variations, alternatives, and modifications. As shown, an optical input signal 10 is launched (from a laser) in a channel to a first directional splitter. The power of the input laser signal 10 is split equally into two optical paths 11 and 12. Signal waves carried in the two optical paths travel through two waveguides 21, 22 made by heavily p-doped silicon-based material with linear form factor over a buried oxide layer (not shown) under standard silicon CMOS technology. Along a middle region in parallel to the two waveguides, a heavily n-doped electrode 30 is laid to form two p-n junctions respectively throughout whole lengths of the two waveguides 21 and 22. Across one or both the p-n functions, free carriers can be depleted by applying an electric field to modify the refractive index in the waveguide material, i.e., the MZM material along the whole length of waveguide 21 or 22, and, thus, modify the phase for the light wave through each path, forming a differential structure of the MZ modulator 100. The amplitude modulation occurs when the phase delayed signals in the two arms are combined at the output MMI coupler 70.

In a specific embodiment, both waveguides 21, 22 at respective input end and output end are configured to couple to a DC current source receiving a modulation electric field (Vcc). The modulation electrical voltage Vcc drives a current flowing through the entire MZM material in the waveguide 21 associated with a resistance to cause free-carrier depletion effect within the semiconductor MZM material. Similar circuit is setup for the second waveguide 22. A DC bias voltage V_{bias} is applied to the heavily n-doped middle electrode 30 (shared for two p-n junctions) to set the MZM at an ideal phase position on signal transfer function which is further tuned by two respective electrical signals in two waveguides (21 and 22). Each RF electrical signal interacts on the corresponding optical signal in each path to provide modulation for the input signal with a “differential” structure associated with the two waveguides due to the free-carrier depletion induced phase interference between the two light waves. The two light waves are then combined into one fiber via a multimode interference (MMI) coupler 70 to provide a modulated output 72 and a complementary output 71. The modulated output 72 carries output laser signal after MZM modulation. The complementary output 71 is coupled to a photodiode (PD) 80 for feeding unused part of the output signal back for the MZM controller 100 (output signal powers of 80 and 72 are equal, just 180° out of phase).

In addition to using V_{bias} to tune modulator operating point, two thermo-optical controllers 51 and 52 are respectively inserted near the output end of each (before the two light waves are combined) of the two optical paths for providing further quadrature control on the transfer function of the above laser signal intensity modulation in terms of two control signal Itrim1 and Itrim2. It is mainly for compensating for the possible temperature or environment related drifts and for locking the device operating point so as to keep stable operation conditions. In a specific embodiment, the complementary output 71 to collect a fractional powered signal bearing all information of modulated signal in the modulation output 72. The photodiode 80 is configured to detect one or more feedback (electrical) signals including a dither frequency signal for controlling Itrim1 and Itrim2 for achieving desired amplitude modulation for the input optical signal 10. Tuning Itrim1 and Itrim2 current signals can be used for stabilizing the operating point of the output signal 72. The MZM phase can be tuned to be “in-phase” or out-of-phase using forward bias section via Itrim1 and Itrim2.

In an embodiment, for over-life phase control an option is to use a low frequency small dither signal on the Itrim1 and Itrim2. The dither signal then is detected using the PD 80 and is fed back for the signal modulation scheme. For Quadrature (transfer curve) bias lock, the goal is to adjust Itrim1 or Itrim2 to maximize the dither signal at first harmonic f1, or third harmonic 3f1, . . . , and minimize second harmonic 2f1, or fourth harmonic 4f1, . . . . Another option for phase control it to add a low frequency dither signal f1 to the driver output amplitude while still achieving similar frequency detection by the PD 80 and the Itrim1 or Itrim2 is maximized at the dither signal f1, or 3f, 1, . . . , and minimized at 2f1, or 4f1, . . . . An alternative embodiment includes adding low frequency ditcher signal to an RF electrical signal through the MZM material for signal modulation.

In an embodiment, the MZM 100 is associated with a MZM length which is physical length of the (silicon-based) MZM material in either path 21 or 22. The MZM is implemented in telecommunication with a standard non-return-to-zero (NRZ) line code which is a binary code in which “1”s are represented by one significant condition (usually a positive voltage) and “0”s are represented by some other significant condition (usually a negative voltage), with no other neutral or rest condition.

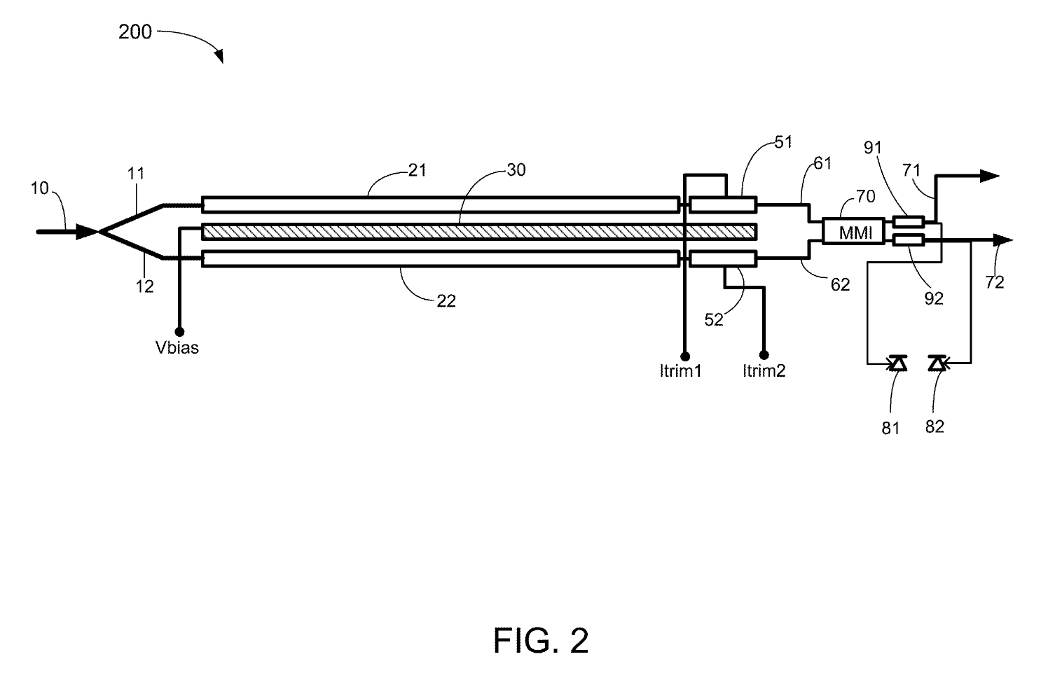

FIG. 2 is a simplified diagram of a MZM with tapped signals from both modulated output and its complementary output as merit for control according to an embodiment of the present invention. This diagram is merely an example, which should not unduly limit the scope of the claims. One of ordinary skill in the art would recognize many variations, alternatives, and modifications. As shown, a MZM 200 is substantially similar to MZM 100 in device layout and control setup. The MZM phase bias is tunable using forward biased section via Itrim1 and Itrim2 to provide differential amplitude modulation. PD 80 is still used for detecting the dither signal f1 in association with the input signal 10 during bias control. The only difference of this MZM 200 from the MZM 100 shown in FIG. 1 is that two low percentage tap couplers 91 and 92 are included at both modulated output and its complementary output to tap the corresponding modulated optical signals. Each tapped optical signal of the two outputs is converted to electrical power signal respectively by a first PD 81 and a second PD 82 for maintaining quadrature of the transfer function. Using these converted electrical power signals as feedback, the light waves split from input optical signal 10 into the two paths of MZM 200 can be maintained with appropriate power ratio over life. Alternatively, two electrical power signals, denoted simply as PD1 or PD2, can be used for constructing a numeric ratio of (PD1−PD2)/(PD1+PD2) as signed figure of merit for modulation control.

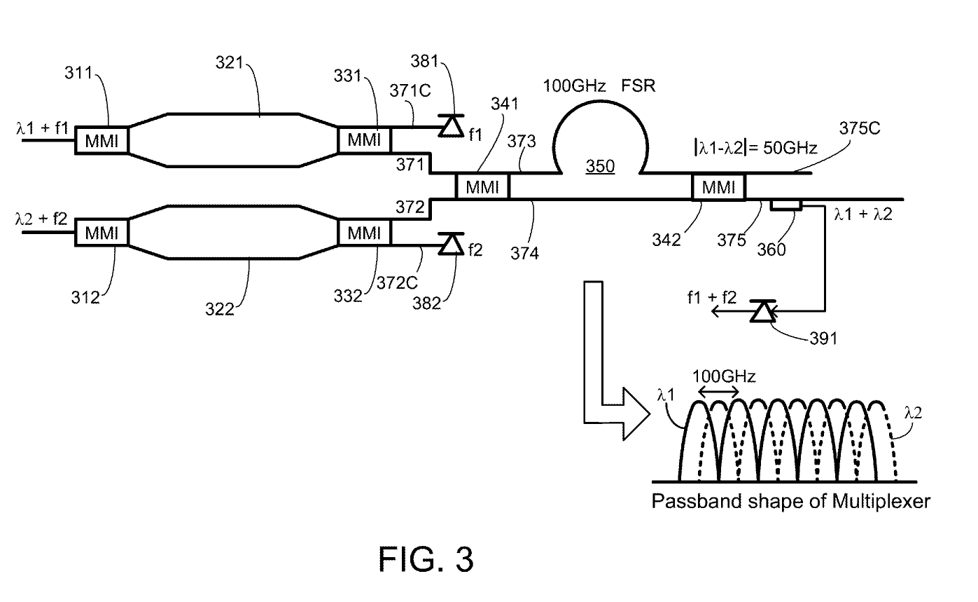

FIG. 3 is a simplified diagram of an integrated two-channel spectral combiner and wavelength locker implemented in silicon photonics according to an embodiment of the present invention. This diagram is merely an example, which should not unduly limit the scope of the claims. One of ordinary skill in the art would recognize many variations, alternatives, and modifications. As shown, optical input signal λ1 in a first channel with an added dither signal f1 and optical input signal λ2 in a second channel with an added dither signal f2 are coupled via two 1×2 MMI splitters 311 and 312 into respectively with two MZMs 321 and 322. In other words, a laser signal fed in each corresponding channel is subjected to amplitude differential modulation by corresponding MZM. The dither signal f1/f2 is added on MZM 321/322 via corresponding Itrim1 and Itrim2. Each MZM, 321 or 322, is substantially the same as the MZM 100 shown in FIG. 1 or MZM 200 shown in FIG. 2.

After passing through the MZM modulation length, a modulated optical signal in the first channel is outputted to a first output port 371 via a 2×2 MMI coupler 331. Another modulated optical signal in the second channel is outputted to a second output port 372 via another 2×2 MMI coupler 332. The other output arm of either above two MMI couplers 331 or 332 is a complementary output port 371C or 372C for drawing half or smaller fraction of modulated signal. In the first channel, the corresponding fraction of modulated signal in the complementary output port 371C is converted to electrical signal by a photodiode 381 for detecting the dither frequency signal f1. Similarly in the second channel, the corresponding fraction of modulated signal in the complementary output port 372C is coupled to a photodiode 382 for detecting the dither signal f2. The dither signal f1 or f2 is added into corresponding MZM associated with the corresponding input laser signal λ1 or λ2 in first or second channel and is utilized for the MZM to perform signal modulation in each channel. Each dither signal can be added or mixed with an optical signal either thermally by changing a thermoelectric cooler or electrically by changing bias current directly. The modulated optical signal passes through corresponding output port 371 with a wavelength approximately at λ1 for the first channel or in output port 372 with another wavelength approximately at λ2 for the second channel.

In an embodiment, the two channels above may be selected to be aligned with particular one of ITU grid wavelengths for DWDM optical communication with a narrow passband. For example, the wavelengths of the two channels λ1 and λ2 have 50 GHz spacing.

Alternatively, the two channels may be selected to be aligned with two neighboring wavelengths for CWDM optical communication with a wider passband.

Referring to FIG. 3, an integrated two-channel spectral combiner and wavelength locker 350 includes a 2×2 MMI coupler at input and a 2×2 (or 1×2) MMI coupler 342 at output, unlike a conventional 3 dB coupler, is provided for combining the two modulated optical signals λ1 and λ2 from output ports 371 and 372 and locking corresponding wavelengths at the same time. In an example, the bandwidths of the spectral passbands are 50 GHz spaced at 100 GHz (as seen in an inserted graph at lower right of FIG. 3) for each channel. Through the input 2×2 MMI coupler 341, the modulated signal λ1 in the first channel splits in a first half to a first waveguide 373 and a second half to a second waveguide 374. At the same time, the modulated signal λ2 in the second channel splits in a first half to the first waveguide 373 and a second half to the second waveguide 374.

In a specific embodiment, the first waveguide 373 in the integrated two-channel spectral combiner and wavelength locker 350 is made longer than the second waveguide 374 by a predetermined length which provides a delayed phase shift to the optical signals traveling in the first waveguide 373. In other words, a delay-line interferometer is formed with the two waveguide paths having different lengths. When the two halves of optical signals (having the same wavelength) meet again in the output MMI coupler 342, this delayed phase shift, if properly tuned, would lead to an interference spectrum with enhanced passbands at particular phases. This applies to both optical signals λ1 and λ2.

The output MMI coupler can be a 2×2 coupler while having its complementary output 375C terminated or is simply a 2×1 coupler so that both optical signals λ1 and λ2 are outputted to a main output 375. In an example, the optical signal λ1 from the first channel and optical signal λ2 from the second channel has 50 GHz difference, i.e., ∥λ1−X2∥=50 GHz. The bandwidth of a spectral passband can be 50 GHz for each optical signal and spaced at 100 GHz from a neighboring signal. Once the length difference between the first waveguide 373 and the second waveguide 374 is properly designed, the second optical signal, having substantially the same bandwidth and passband shape can be set to a spectrum with interleaved passbands for combined signals λ1+λ2. Over the main output 375 a low percentage tap device 360 can be added to collect a small fraction of a combined signal λ1+λ2 from which the dither signals f1+f2 can be detected by a photodiode 391 and utilized for control of wavelength locking. A method of performing the wavelength locking using the above integrated two-channel spectral combiner and wavelength locker 350 is provided below.

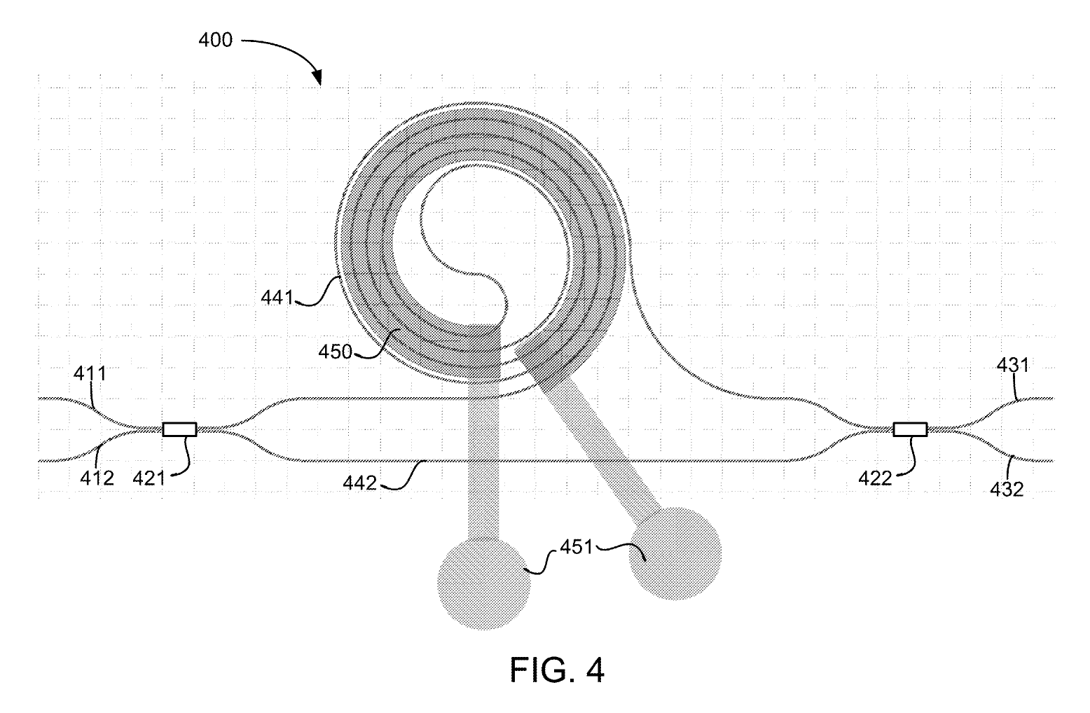

FIG. 4 is a simplified diagram showing a waveguide configuration of the integrated two-channel spectral combiner and wavelength locker according to an embodiment of the present invention. This diagram is merely an example, which should not unduly limit the scope of the claims. One of ordinary skill in the art would recognize many variations, alternatives, and modifications. As shown, a device 400 of integrated two-channel spectral combiner and wavelength locker includes two waveguides 441 and 442 respectively coupled to an input 2×2 coupler 421 and an output 2×2 coupler 422. The input 2×2 coupler 421 is configured to have its two input ports to respectively receive two input optical signals 411 and 412. The output 2×2 coupler 422 is configured to have its two output ports to respectively output two output signals 431 and 432. In an example, Silicon (a part of SOI wafer) is used as a waveguide material, although any suitable waveguide materials may be used on any substrates, for example, SiN on SOI, InGaAsP on InP, InAlGaAs on InP, etc. In a specific embodiment, the device 400 has an overall dimension of about 200 μm from two input ports to two output ports and about 100 μm in cross direction. This is much more advantageous than conventional 3 dB coupler or Etalon-based interleaver in terms of feasibility to be integrated with other silicon photonics devices in a same chip with same or even better optical performance in WDM multi-channel signal transmission.

In an embodiment, one of the two waveguide 441 and 442 is deliberately designed to have a longer length in its path than the other one to form a delay-line interferometer (DLI). In particular, the one with longer length is laid in a configuration of two interleaved spiral paths. One spiral path includes a mostly counter-clockwise section and another spiral path includes partially clockwise section to minimize die-size. The factors to yield a desired spectrum include the path length difference L, which follows this equation L=C₀/N_{g}/FSR (C₀ is speed of light in vacuum, N_{g} is group index of the waveguide, FSR is free spectral range which is 100 GHz in one case of FIG. 3). For example, L is merely 700 μm for meeting requirement of phase delay with 100 GHz FSR spacing for each ITU grid channel having a passband of 50 GHz. Alternatively, another value of L can be properly selected for meeting requirement of phase delay with 50 GHz FSR spacing for each ITU grid channel with a passband of 25 GHz. Other configuration is also possible. Note, there should be no wavelength limit for this device to work in principle. However, as N_{g} is a factor having partial wavelength dependence, the path length difference needs to be adjusted when applications with different wavelengths (like 1300 nm vs. 1550 nm) other than standard ITU grid are involved.

In an specific embodiment, the integrated two-channel spectral combiner and wavelength locker 400 includes a resistive heater 450 formed overlying the waveguide path region having two embedded electrodes 451 for power supply and thermistor contact. The heater is used to tune the DLI peak to the desired operation wavelength, such as those following ITU grid. The DLI peak wavelength can be off from the desired one due to process variation during fabrication or environment temperature under operation. The heater is aimed to provide a desired temperature for compensating the group refractive index change due to variation of temperature the device to stabilize the operation wavelength so that it can be aligned to a desired value of ITU Grid. Especially, when it is applied for DWDM high data rate optical communication, bandwidth of each channel can be 50 GHz, or 25 GHz, or 12.5 GHz, a proper wavelength locking scheme for the optical signal in the DWDM optical transmission over wide range environmental temperatures is essential.

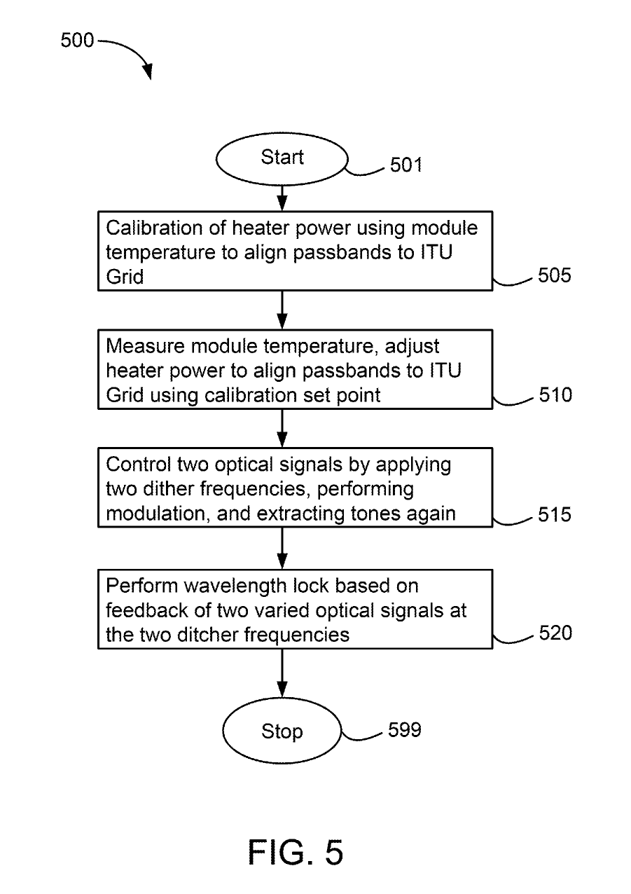

FIG. 5 is a simplified flowchart of a method for wavelength locking control using the integrated two-channel spectral combiner and wavelength locker according to an embodiment of the present invention. This diagram is merely an example, which should not unduly limit the scope of the claims herein. The method 500 includes the following processes:
501: Start,
505: Calibration
510: Set point
515: Control Sigal
520: Feedback
599: Stop

The above sequence of processes provides a wavelength locking method for DWDM signal transmission in silicon photonics based on the integrated two-channel spectral combiner and wavelength locker 400 according to an embodiment of the present invention. Of course, the sequence of processes is merely an example, one or more processes can be added, inserted, switched in order, replaced by one or more alternative processes and can be applied in accordance with other types of wavelength locking device without departing from the scope of the claims herein. Further details of the method can be found throughout the present specification and more particularly below.

In an embodiment, as the method 500 starts at process 501, a delayed-line-interferometer-based interleaver, i.e., an integrated two-channel spectral combiner and wavelength locker 400 shown in FIG. 4, is used for setting (at least two channels of) a DWDM multiplexer module to be on ITU grid and locking the wavelength of each channel. In general, the DWDM multiplexer module can includes 40, 72, 88, 160, or other number of channels on various bands of ITU grid with different channel bandwidth and free-spectral range between channels. In a specific embodiment, the DWDM multiplexer module comprises a multi-channel array waveguide grating (AWG) based DWDM multiplexer integrated with a plurality of delayed-line-interferometer-based interleavers. A Calibration process 505 for countering the temperature effect is firstly performed to any wavelength locking device (such as the waveguide-based device 400 of FIG. 4) associated with the DWDM multiplexer module. By varying a case temperature of the DWDM multiplexer module, a surface temperature of the wavelength locking device is measured using a thermistor or RTD. Accordingly, a heater associated with the wavelength locking device as wavelength combiner and locker is tuned (of its resistive power) to compensate the variation of temperature so that the output wavelengths are aligned to particular value, for example, a peak of a passband of a ITU grid signal. Through a series of measurements and heater power adjustments, various set points of heating power as a function of surface temperature of the wavelength locking device can be obtained. The calibration information is then stored in a firmware designated for the control of wavelength locking.

In process 510, the method 500 includes measuring the surface temperature of the wavelength locking device (as well as case temperature of DWDM multiplexer module) in an actual operational environment. Then the stored calibration information including all set points is used to adjust the heater power to certain set points for aligning passbands of the combined signals after the wavelength locking device to corresponding channels of the desired ITU grid. Note, this is a continually ongoing process to keep the WDM multiplexer locked to the ITU grid.

In process 515, two independent dither frequency signals f1 and f2 (outside of the two signal bands) are applied particularly to the signal λ1 and signal λ2 respectively. Further, the method employs a low percentage (e.g., 2%) tap coupler placed at output port of the two-channel combiner and wavelength locker to detect total optical power of the combined signals. From the detected output signals, dither signals f1 and f2 can be extracted as feedback control signals for performing wavelength locking functions for corresponding channel wavelengths λ1 and λ2. An alternative way for wavelength lock is to maximize second harmonic of the dither signals f1 and f2 therein.

In process 520, a feedback control is carried for locking a particular channel wavelength to corresponding passband peak position of the combined signal which are varied according to environmental changes. In a specific embodiment, the combined signal corresponds to an interference spectrum after an AWG-based multiplexer. The interference spectrum includes a channel passband characterized by Gaussian type transfer function peaked at a corresponding channel wavelength. After each DLI-based two-channel combiner and wavelength locker, the interference spectrum of a particular optical signal includes a passband characterized by a raised cosine type transfer function peaked at corresponding channel wavelength. The feedback control is executed by firstly varying signal wavelengths λ1 and λ2 by taking an arbitrary small change in either temperature of a thermoelectric cooler/heater associated with a laser device (such as a DFB laser) or a bias current for driving the laser device. Then measurements of the strength of the combined signal at the corresponding dither frequencies f1 and f2 are performed. According to corresponding channel passband transfer function, a first derivative of the combined signal is calculated as a function of the temperature or bias current of the laser device. Due to the symmetric characteristics of the channel passband of corresponding interference spectrum, a location degeneracy may exist with a certain signal strength. But the sign of the first derivative can be either positive or negative which is used to break the location degeneracy. Both the strength of the combined signal and the sign of the first derivative can be used to determine the location of the optical signal associated with particular channel (λ1 or λ2). Finally, by maximizing the detected power of the combined signal while null the sign of the first derivative to lock to the peak of a multiplexer-combined channel passband to a desired ITU grid. The method 500 of combining two DWDM optical channels and locking corresponding channel wavelength ends at process 599.

In another specific embodiment, the feedback control process for wavelength locking includes a TOSA (Transmit Optical Sub-Assemblies) control for adjusting the laser device (such as a DFB laser). For example, a DFB laser at manufacture will be performed a test to adjust the laser device up to its maximum range until its output signal meets performance spec. A photodiode used as a back facet monitor detects a corresponding PD current and record it in memory as “ref”. This recorded “ref” information will be used as reference for a current driver to bias the DFB laser during real-life operation in connection to the wavelength locking process mentioned above.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A silicon photonics device for combining two optical signals while locking corresponding wavelengths, comprising:
a first waveguide having a first path length from a first end to a second end laid in a first region of the substrate;
a second waveguide having a second path length from a third end to a fourth end, the second path length being longer than the first path length by a delayed-line length laid in a second region of the substrate;
a heater component overlying substantially entire second region of the substrate;
an input coupler configured to connect a first signal with a first wavelength and a second signal with a second wavelength to both the first end of the first waveguide and the third end of the second waveguide;
an output coupler configured to connect the second end of the first waveguide and the fourth end of the second waveguide to an output port with an combined signal comprising a first interference spectrum of the first signal with a first free spectral range associated with the first wavelength interleaved with a second interference spectrum of the second signal with a second free spectral range associated with the second wavelength;
wherein the delayed-line length and the heater component are configured to determine the first free spectral range being equal to the second free spectral range and equal to twice of difference between the first wavelength and the second wavelength as the first wavelength and the second wavelength are respectively locked to corresponding channels of ITU grid.

2. The silicon photonics device of claim 1 wherein the first signal comprises a laser signal at the first wavelength selected from any channel of ITU grid and the second signal comprises a laser signal at the second wavelength selected from any channel of ITU grid including a neighboring channel next to the first wavelength.

3. The silicon photonics device of claim 2 wherein the ITU grid comprises a channel spacing selected from 50 GHz, 25 GHz, and 12.5 GHz.

4. The silicon photonics device of claim 1 wherein the first signal and the second signal are respectively modulated by a first and a second Mach-Zehnder modulators before connecting to the input coupler.

5. The silicon photonics device of claim 1 wherein each of the first/second interference spectrum comprises a passband characterized by a substantially symmetric curve relative to the first/second wavelength at peak.

6. The silicon photonics device of claim 1 wherein the first waveguide laid in a first region of the substrate comprises silicon material arranged in a linear shape having a length substantially equal to the first path length.

7. The silicon photonics device of claim 1 wherein the second waveguide laid in a second region of the substrate comprises silicon material arranged a double spiral linear shape having a cross dimension of about half of the first path length.

8. The silicon photonics device of claim 1 wherein the substrate is a silicon-on-insulator substrate.

9. The silicon photonics device of claim 1 wherein the first path length is about 100 μm and the second path length is about 700 μm longer than the first path length.

10. The silicon photonics device of claim 1 wherein the input coupler is a 2×2 multimode interference coupler.

11. The silicon photonics device of claim 1 wherein the output coupler is either a 2×1 multimode interference coupler or a 2×2 multimode interference coupler having at least one output port terminated.

12. The silicon photonics device of claim 4 wherein the first signal and the second signal are configured to respectively mix with a first dither signal and a second dither signal added respectively on the first Mach-Zehnder modulator and the second Mach-Zehnder modulator, each of the first and second dither signal having a different frequency from either the first or the second signal.

13. The silicon photonics device of claim 12 further comprising a low percentage tap coupler connecting to the output port and a photodiode for collecting and converting a fraction of optical power of the combined signal to an electrical signal from which the first dither signal and the second dither signal are extracted.

14. The silicon photonics device of claim 12 wherein the first/second dither signal is configured to mix respectively with the first/second signal by varying the first/second wavelength by small change in temperature or bias current for controlling the laser signal and locking the first/second wavelength to corresponding channel of ITU grid by maximizing fraction of optical power of the combined signal detected by the photodiode.

15. A method of using a silicon photonics device for combining two optical signals while locking corresponding wavelengths, the method comprising:
coupling a first optical signal characterized by a first wavelength to split into a first waveguide path having a first length and a second waveguide path having a second length, the second length being longer than the first length by a specific delayed-line length to provide a first interference spectrum having a first free-spectral range between two successive passband peaks associated with the first wavelength;
coupling a second optical signal characterized by a second wavelength to split into the first waveguide path and the second waveguide path to provide a second interference spectrum having a second free spectral range between two successive passband peaks associated with the second wavelength, the second free spectral range being equal to the first free-spectral range and being configured to be equal to twice of difference between the first wavelength and the second wavelength;
incorporating a first dither signal into the first optical signal;
incorporating a second dither signal into the second optical signal;
forming a combined signal in one output port of both the first waveguide path and the second waveguide path, the combined signal comprising the first interference spectrum and the second interference spectrum;
extracting the first dither signal and the second dither signal from the combined signal;
measuring a power strength of a tapped fraction of the combined signal and calculating first derivatives of the power strength respectively at the first dither signal and the second dither signal; and
identifying and locking the first wavelength and the second wavelength by maximizing the power strength and nulling the first derivatives respectively at the first dither signal and the second dither signal.

16. The method of claim 15 wherein coupling a first optical signal comprises connecting a first Mach-Zehnder modulator between a first laser device and a first input port of a 2×2 multi-mode interference coupler.

17. The method of claim 16 wherein coupling a second optical signal comprises connecting a second Mach-Zehnder modulator between a second laser device and a second input port of the 2×2 multi-mode interference coupler.

18. The method of claim 17 wherein the 2×2 multi-mode interference coupler comprises a first output port connecting to the first waveguide path and a second output port connecting to the second waveguide path, both the first waveguide path and the second waveguide path being made of silicon material built on a silicon-on-insulator substrate.

19. The method of claim 17 wherein incorporating the first/second dither signal comprises adding a low frequency tone on the first/second Mach-Zehnder modulator as a means for locking wavelength of the first/second optical signal.

20. The method of claim 15 further comprising adding a heater component for setting a temperature environment for both the first waveguide and the second waveguide having the specific delayed-line length to tune passbands of the first interference spectrum and the second interference spectrum to corresponding channels of ITU grid.
